(19) United States
(12) Patent Application Publication
(10) Pub. No.: US 2012/0055107 A1
(43) Pub. Date: Mar. 8, 2012

(54) WINDOW CASING

(75) Inventors: David Wayne Butler, Vienna, WV (US); Edward A. Heck, Belpre, OH (US)

(73) Assignee: Simonton Building Products, Inc., Parkersburg, WV (US)

(21) Appl. No.: 13/222,043

(22) Filed: Aug. 31, 2011

Related U.S. Application Data
(62) Division of application No. 12/355,175, filed on Jan. 16, 2009.

(51) Int. Cl. E06B 1/36

(52) U.S. Cl. 52/213

(57) ABSTRACT

Window assemblies that include window casings are disclosed. One exemplary embodiment of a window assembly includes a window casing that is assembled with a window frame by clips. Each clip is compressed between the window casing and the window frame as the window casing is moved toward an installed position. The clips expand at the installed position to retain the window casing to the window frame at the installed position. Another exemplary embodiment of a window assembly includes a window casing with a top member and side members that are connected by mitered mating surfaces and provide the appearance that the top member and the side members are butt jointed.

### RELATED APPLICATIONS

The present application is a divisional application of 12/355,175 filed on Jan. 16, 2009, titled “Window Casing” and claims the benefit of U.S. provisional application Ser. No. 61/025,050, filed on Jan. 31, 2008, titled “Window Casing.” U.S. provisional application Ser. No. 61/025,050 is incorporated herein by reference in its entirety.

### BACKGROUND OF THE INVENTION

The exterior side of a window of a house may be trimmed with a casing to provide an aesthetically pleasing exterior look. Typically, the casing is constructed around the frame of the window at the site where the window is installed. For example, top, bottom, and two side pieces are cut to length at the installation site from an elongated member or members and are assembled around the frame of the window. Alternatively, the casing is assembled with the window frame by the manufacturer. The window manufacturer ships window assemblies that include a window casing assembled to a window frame to the site where the window assembles are installed.

### SUMMARY

The present application discloses embodiments of window assemblies that include window casings. One exemplary embodiment of a window assembly includes a window casing that is attached or assembled with a window frame by clips. Each clip is compressed between the window casing and the window frame as the window casing is moved toward an installed position. The clips expand at the installed position to retain the window casing to the window frame at the installed position.

Another exemplary embodiment of a window assembly includes a window casing with a top member and side members that are connected by mitered mating surfaces and provide the appearance that the top member and the side members are butt jointed.

### BRIEF DESCRIPTION OF THE DRAWINGS

FIG. 1A is a schematic illustration of an exemplary embodiment of a window casing being assembled to a frame of a window;

FIG. 1B illustrates the window casing of FIG. 1A being pressed onto the window frame to secure the window casing to the window frame;

FIG. 1C illustrates an exemplary embodiment of a window casing attached to a window frame by a clip;

FIG. 1D illustrates another exemplary embodiment of a window casing attached to a window frame by a clip;

FIG. 2 is an exploded perspective view of an exemplary embodiment of a window casing,

FIG. 3 is a rear exploded view of the window casing of FIG. 2.

FIG. 4 is a partial exploded perspective view of the window casing of FIG. 2 illustrating attachment of a casing head member to a casing jamb member;

FIG. 5 is a partial exploded perspective view of the window casing of FIG. 2 illustrating the casing head member and the casing jamb member;

FIG. 5A is a partial exploded view of the window casing of FIG. 2 illustrating an optional decorative cover, the casing head member, and the casing jamb member;

FIG. 5B is a front view of the casing components shown in FIG. 5A in an assembled condition;

FIG. 6 is a partial exploded perspective view of the window casing of FIG. 2 illustrating attachment of a casing bull nose member to a casing jamb member;

FIG. 7 is a partial exploded perspective view of the window casing of FIG. 2 illustrating the casing bull nose member and the casing jamb member;

FIG. 8 is a partial exploded perspective view of the window casing of FIG. 2 illustrating the casing bull nose member and the casing jamb member;

FIG. 9A is a front view of the window casing of FIG. 2 in an assembled condition;

FIG. 9B is a side view of the window casing of FIG. 2 in an assembled condition;

FIG. 9C is a rear view of the window casing of FIG. 2 in an assembled condition;

FIG. 10 is an enlarged portion of the window casing shown in FIG. 9C;

FIG. 11 is an enclosed portion of the window casing shown in FIG. 9B;

FIG. 12 is a sectional view taken along the plane indicated by lines 12-12 in FIG. 11;

FIG. 13 is an enlarged portion of the window casing shown in FIG. 9B;

FIG. 14 is a sectional view taken along the plane indicated by lines 14-14 in FIG. 13;

FIG. 15A is a sectional view of the casing head taken along the plane indicated by lines 15-15 in FIG. 2;

FIG. 15B is FIG. 15A with a mounting clip added;

FIG. 16A is a sectional view of the casing jamb taken along the plane indicated by lines 16-16 in FIG. 2;

FIG. 16B is FIG. 16A with a mounting clip added;

FIG. 17 is a sectional view of the casing bull nose taken along the plane indicated by lines 17-17 in FIG. 2;

FIG. 18 is a perspective view of an exemplary embodiment of a window assembly;

FIG. 19 is a perspective view of the window assembly of FIG. 18 with a window casing removed;

FIG. 20 is a perspective view of a frame of the window assembly of FIG. 18;

FIG. 21 is a front view of the frame of FIG. 18;

FIG. 22 is a perspective view of the window casing of FIG. 2 assembled with the window frame of FIG. 20;

FIG. 23 is a front view of the window casing and window frame of FIG. 22;

FIG. 24 is a rear view of the window casing and window frame of FIG. 22;

FIG. 25 is a schematic illustration of a backing being removed from and adhesive on a bull nose member of a window casing;

FIG. 26 is a schematic illustration of a bull nose of a window casing being assembled with a sill of a window frame;

FIG. 27 is a schematic illustration of a bull nose of a window casing assembled with a sill of a window frame;

FIGS. 28A-28C illustrate assembly of a casing jamb with a window frame jamb with a clip;

FIGS. 29A-29C illustrate assembly of a casing head with a window frame head with a clip;

### DETAILED DESCRIPTION

The present application discloses embodiments of window assemblies that include window casings. The features of the different window assemblies may be included in the combinations disclosed in the application or one or more features of one window embodiment may be combined with one or more features of another window embodiment. The description of these embodiments is not intended to limit the scope of the invention or terms of the claims set forth below. The terms as used in the claims have all of their full ordinary meanings.

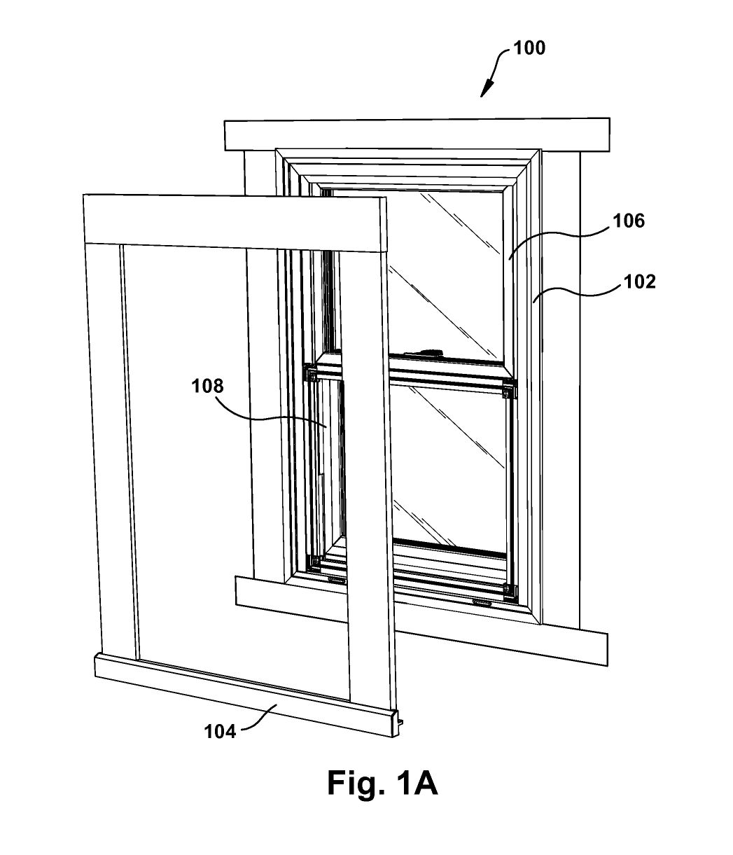

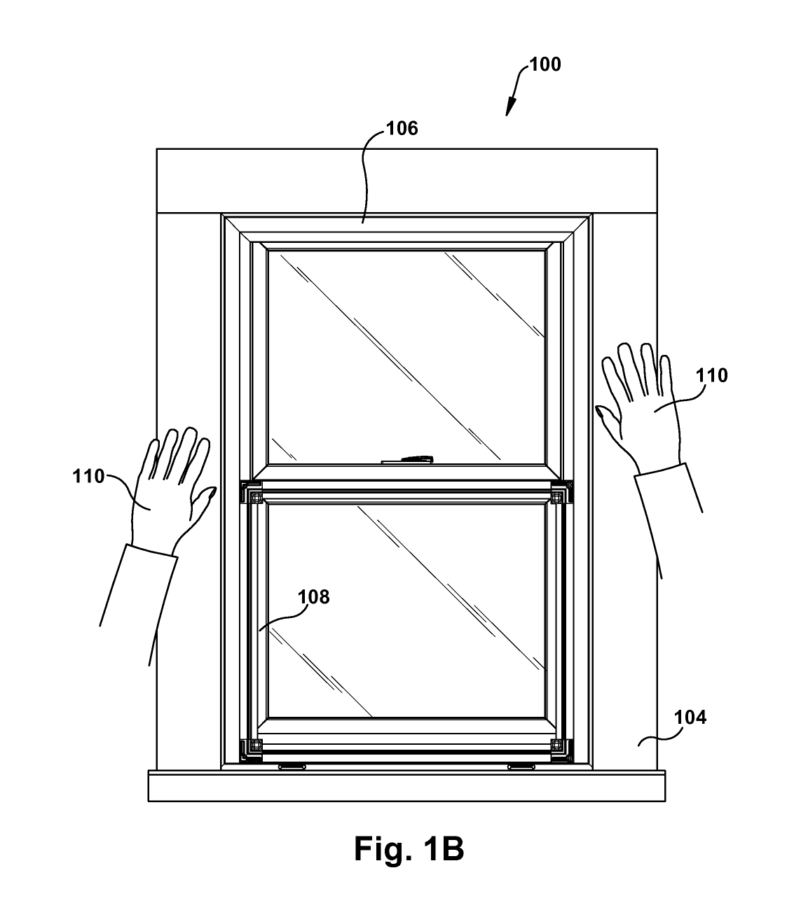

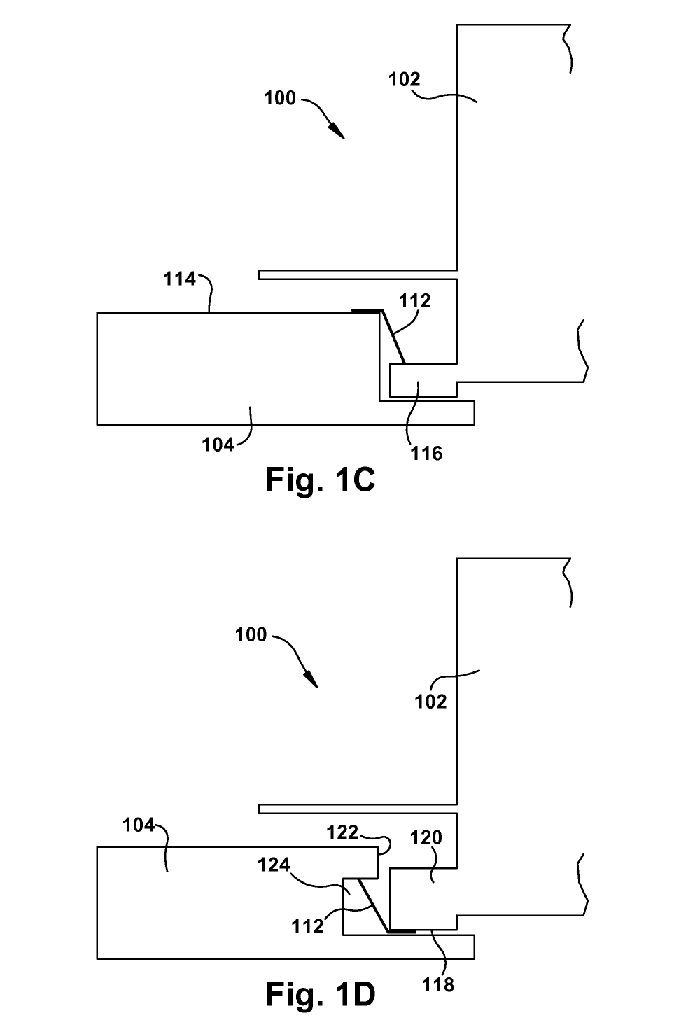

FIGS. 1A-1D illustrate an embodiment of a window assembly 100. The window assembly 100 includes a window frame 102 and a window casing 104. In the example illustrated by FIGS. 1A-1D, an upper sash 106 and a lower sash 108 are mounted in the window frame 102, such that one or both of the sashes are slidable up and down in the frame 102. However, the window assembly 100 may be of any type. Examples of types of windows that may benefit from the concepts disclosed herein include, but are not limited to, single hung windows, double hung windows, casement windows, fixed pane windows, and any other type of window.

Referring to FIGS. 1A and 1B, the window casing 104 is secured to the window frame 102 by simply placing the window casing 104 around the window frame 102 (FIG. 1A) and pressing the window casing 104 toward the window frame 102 as indicated by hands 110 in FIG. 1B. The window casing 104 may be secured to the window frame 102 in a wide variety of different ways. Examples of ways the window casing 104 may be secured to the window frame 102 include, but are not limited to, using mechanical fastening arrangements, such as clips, snaps, expandable fasteners, channel(s) that accept protrusions, etc., using adhesives, such as glue or double sided tape, providing an interference fit between a portion of the window casing and the window frame, etc. Any arrangement where the window casing 104 is secured to the window frame 102 by simply pressing the window casing onto the window frame, where a portion of the window casing captures a portion of the window frame, and/or where a portion of the window frame captures a portion of the window frame can be used.

FIGS. 1C and 1D illustrate examples where the window casing 104 is secured to the window frame 102 with one or more clips 112. When the window casing 104 is initially pressed toward the window frame 102, the clip is compressed between the window casing and the window frame. When the window casing 104 is at the installed position shown in FIGS. 1C and 1D, the clip has expanded to retain the window casing to the window frame 102 at the installed position. The clip 112 or clips can take a wide variety of different forms. Examples of clip types and/or configurations include, but are not limited to, discrete clips mounted to the window casing, discrete clips mounted to the window frame, clips that are integrally formed with the window casing, and/or clips that are integrally formed with the window frame. Any type of clip can be used. When discrete clips are used, the clips may be retained to the window casing or the window frame in a wide variety of different ways. For example, a clip may be screwed, glued, molded in, or clipped onto the window casing or the window frame. One or more clips may be included on the window casing and one or more clips may be included on the window frame.

In the example illustrated by FIG. 1C, the clip 112 is secured to a back side 114 of the window casing. The clip 112 is compressed by a tab 116 of the window frame profile as the window casing 104 is pressed toward the window frame 102. When the window casing 104 is in the installed position, the clip 112 expands to secure the window casing 104 on the window frame 102. In the example illustrated by FIG. 1D, the clip 112 is secured to a front side 118 of a tab 120 of the window frame. The clip 112 is compressed by a tab 122 as the window casing 104 is pressed toward the window frame 102. When the window casing 104 is in the installed position, the clip 112 expands into a pocket 124 of the window casing 104 to secure the window casing 104 on the window frame 102.

A wide variety of different casings can be used in the window assembly 100. For example, the casing 104 may be prefabricated from wood, vinyl, aluminum, wood and plastic composites, or any other material. The members that form the casing can have a wide variety of different configurations. Any configuration of the casing members that allows the casing members to be secured to the window frame by pressing the casing member toward the frame member can be used.

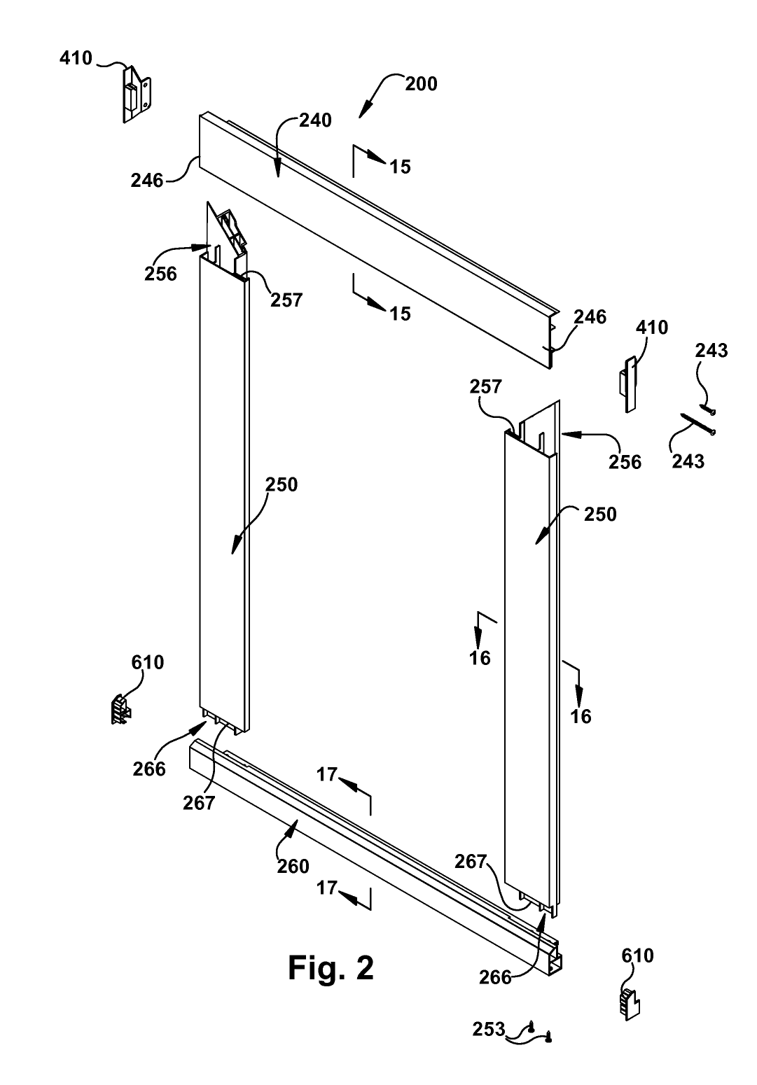

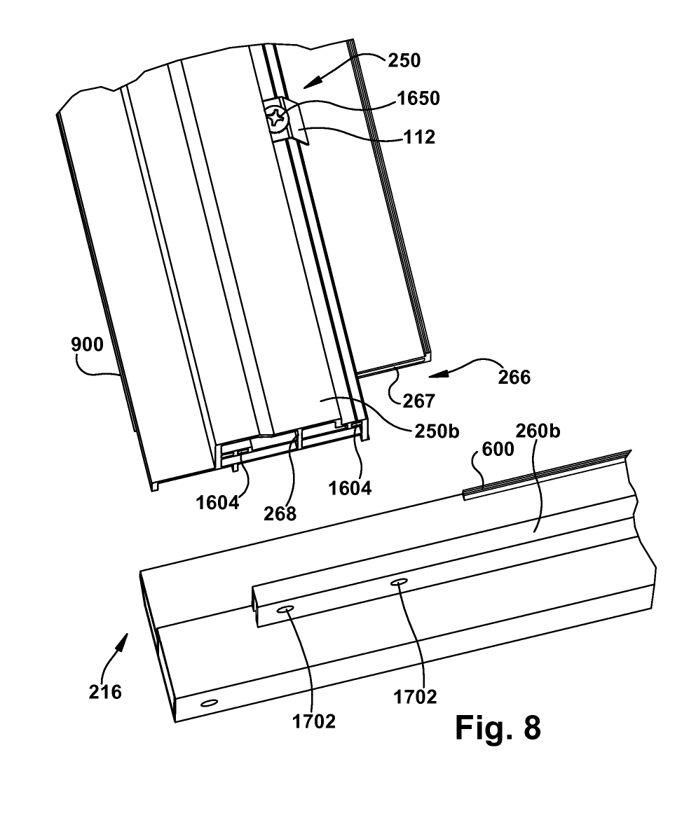

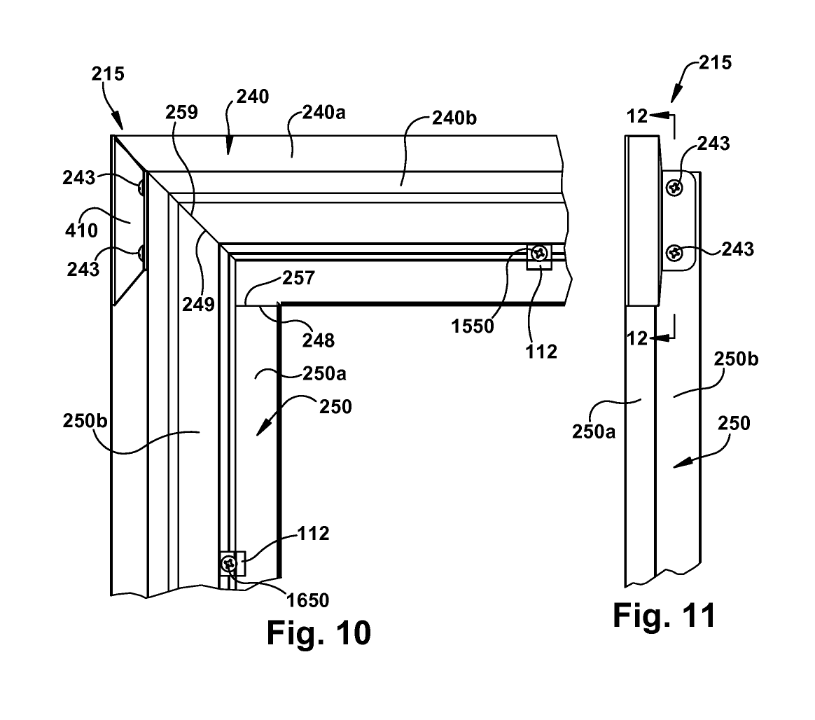

FIGS. 2-17 illustrate an exemplary embodiment of a window casing 200. The window casing 200 may be used in the window assembly 100 or in other types of window assemblies. The casing 200 may include optional clips that allow the casing to be secured to a window frame by simply placing the window casing around the window frame and pressing the casing on. Alternatively, the casing may be secured to a window frame and/or a building structure using conventional fasteners.

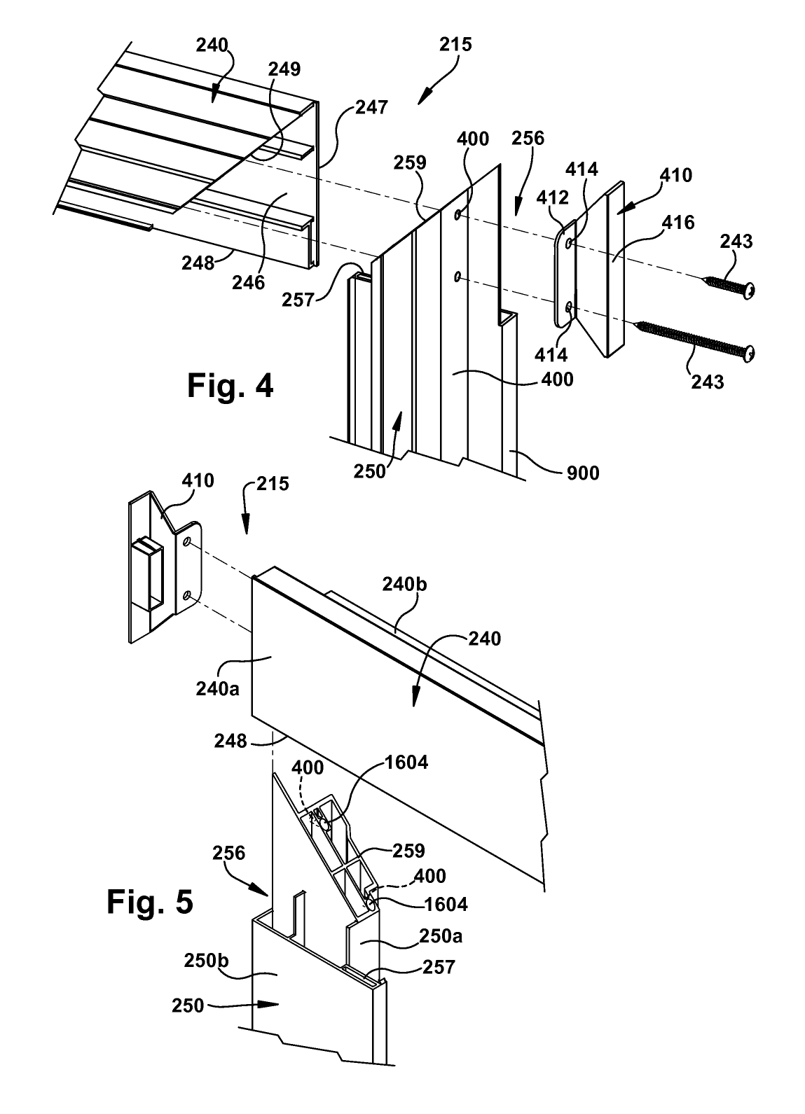

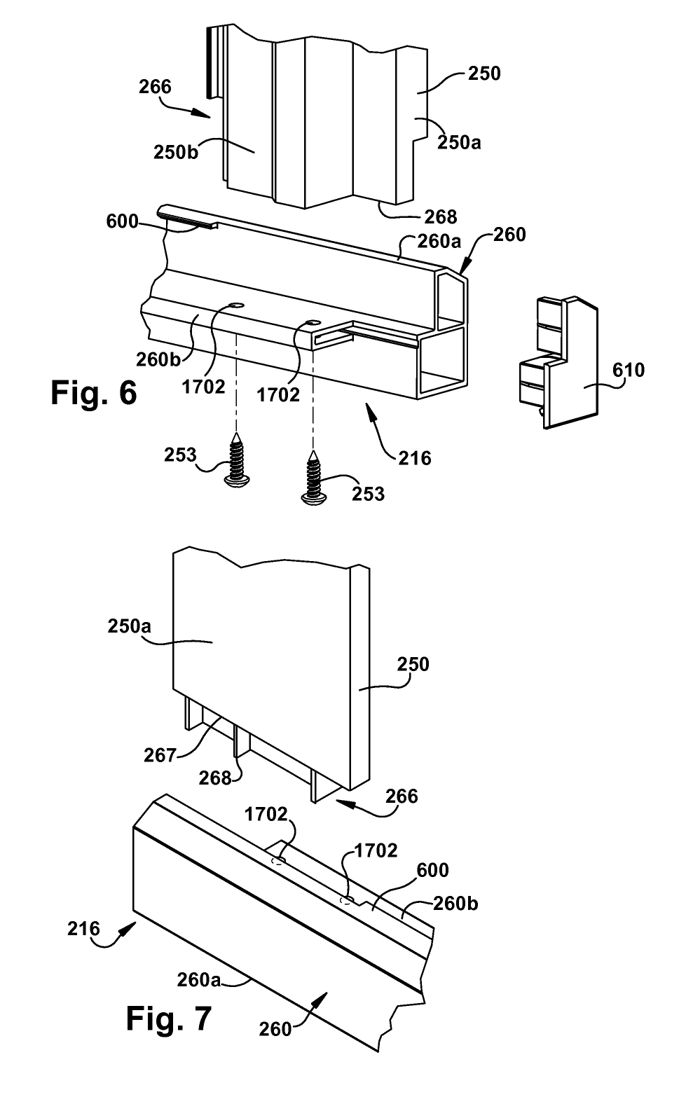

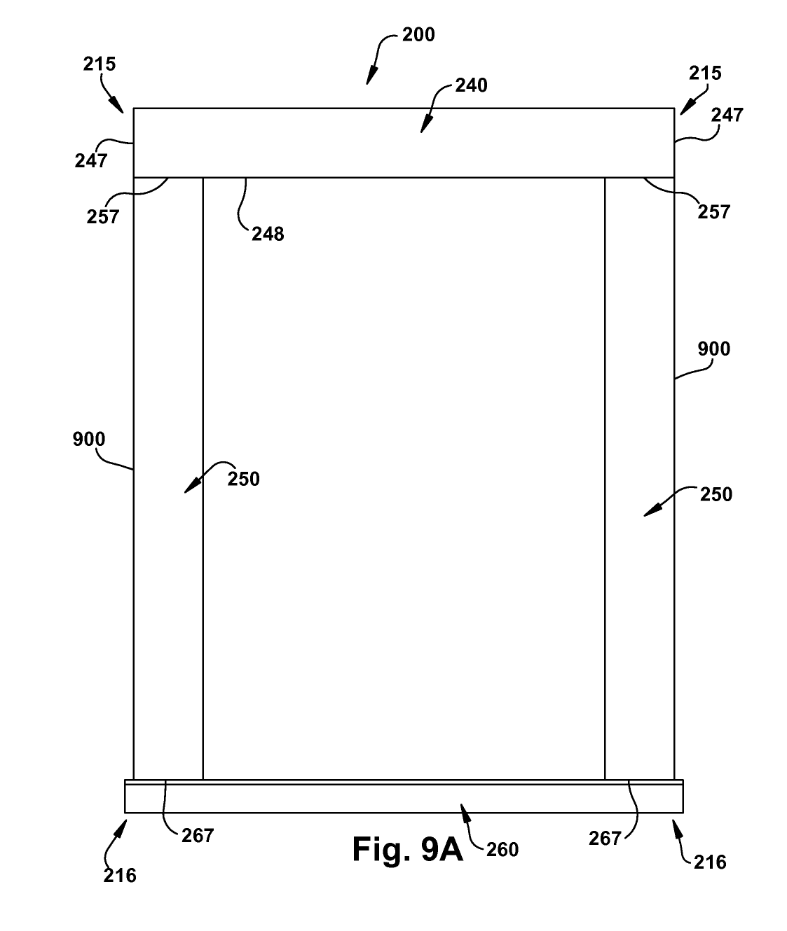

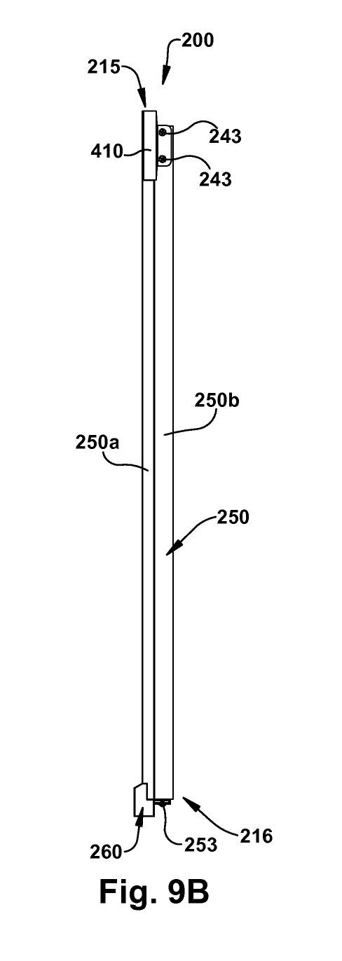

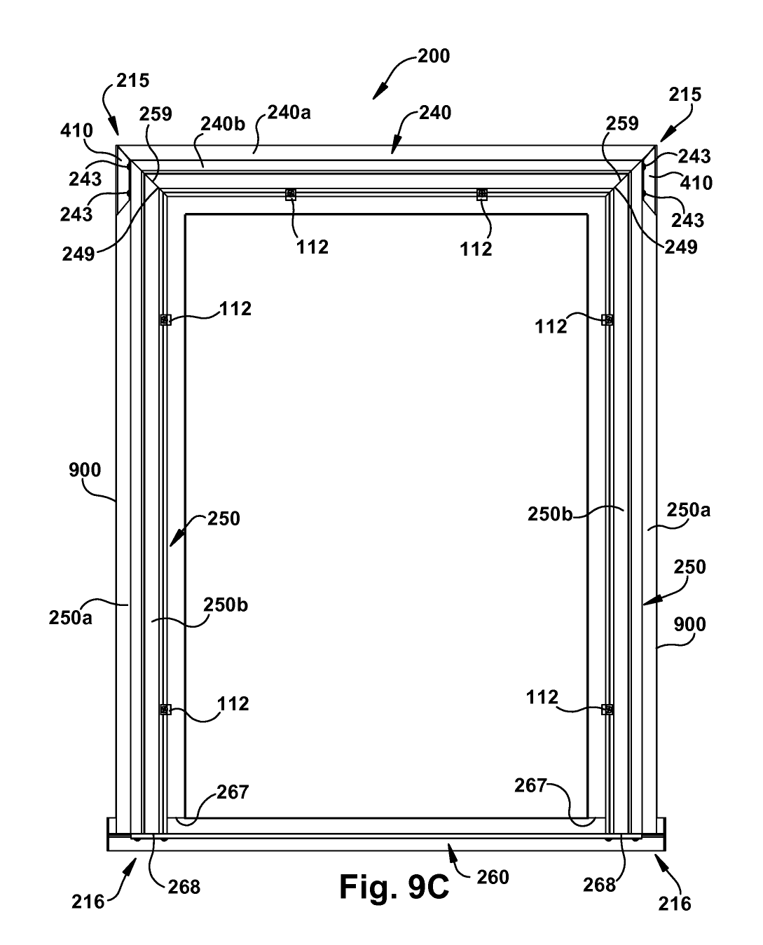

The window casing 200 includes a pair of jamb members 250 which extend vertically, a head rail member 240 that extends horizontally along a top edge of the window casing and a bottom rail member 260 or bull nose that extends horizontally along a bottom edge of the window casing. Referring to FIGS. 4 and 9A-9C, joints 215 between head rail member 240 and the jamb members 250 provide the appearance of a butt joint on the outside or visible surface, while the structural connection of the joints 215 is provided by a mitered joint. Referring to FIGS. 6, 7, 8, 9A-9C, and 13, joints 216 between bottom rail member 260 and the jamb members 250 also provide the appearance of a butt joint on the outside or visible surface. The structural connection of the joints 216 is provided by a hidden butt joint.

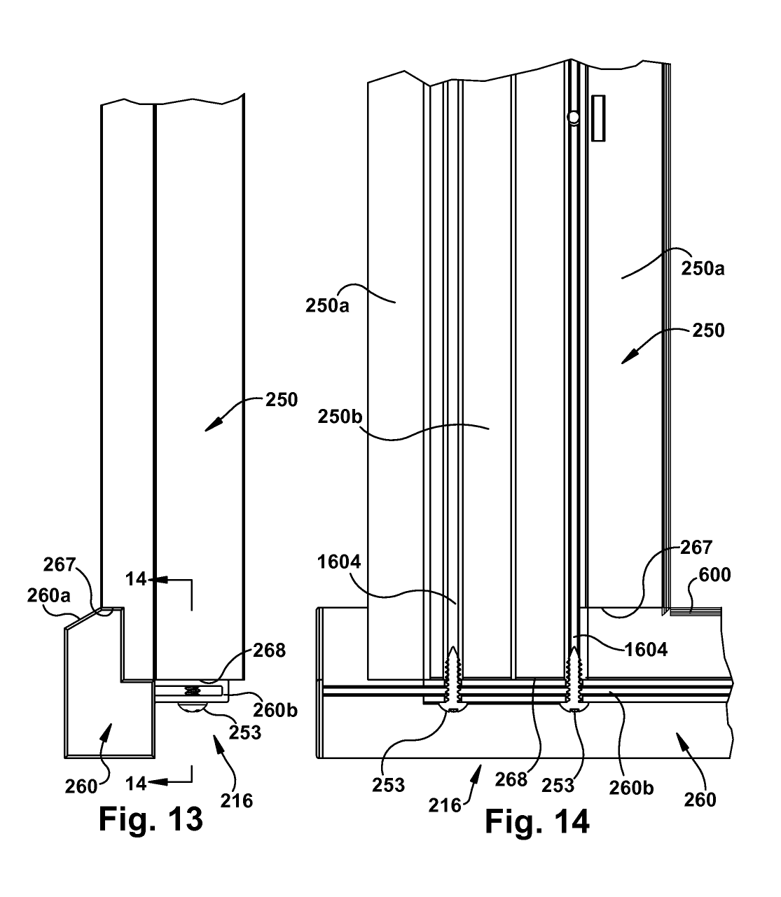

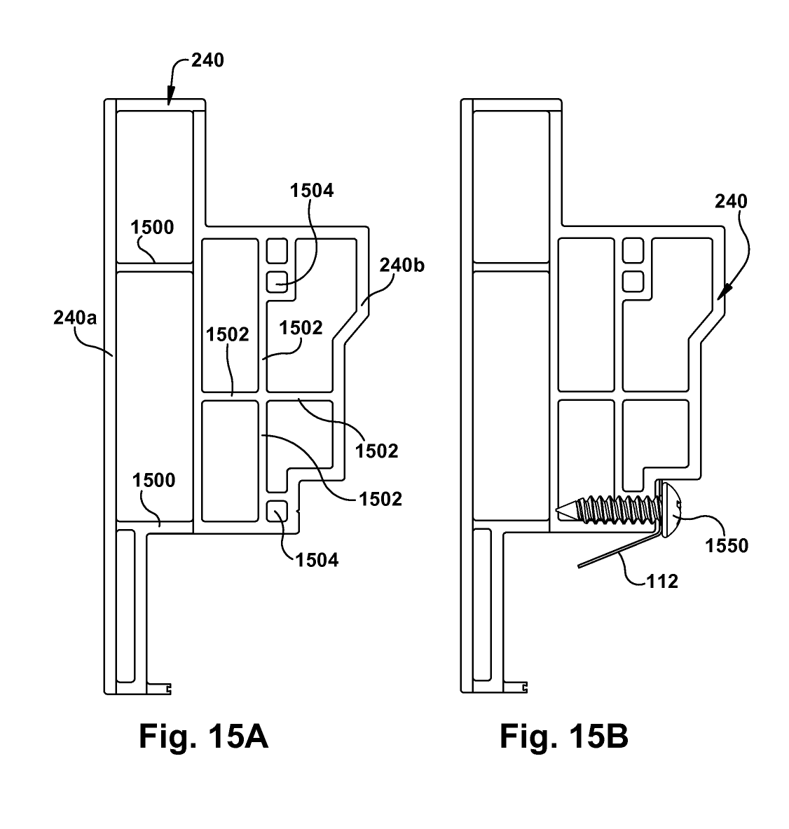

FIG. 15 is a sectional view of the window casing 200 through the top rail member 240. The top rail member 240 may be an extruded or molded plastic, vinyl, wood and plastic composite or similar material. The top rail member 240 includes an exterior visible portion 240a and an interior hidden portion 240b. While these surfaces are generally shown as parallel planes, it will be appreciated that different profiles may be applied to the exterior visible portion 240a, incorporating curves, ridges, grooves, etc. may be used to provide different decorative features on the exterior surface.

The cross-section of the exterior visible portion 240a is selected to have a desired appearance. The exterior visible portion 240a is shaped to approximate a wooden board, such as a 3½″ wide wood board, but the section can be configured to create a wide variety of different appearances. The illustrated exterior portion 240a is generally rectangular. Interior support walls 1500 strengthen the exterior visible portion 240a and may be configured in a wide variety of different ways.

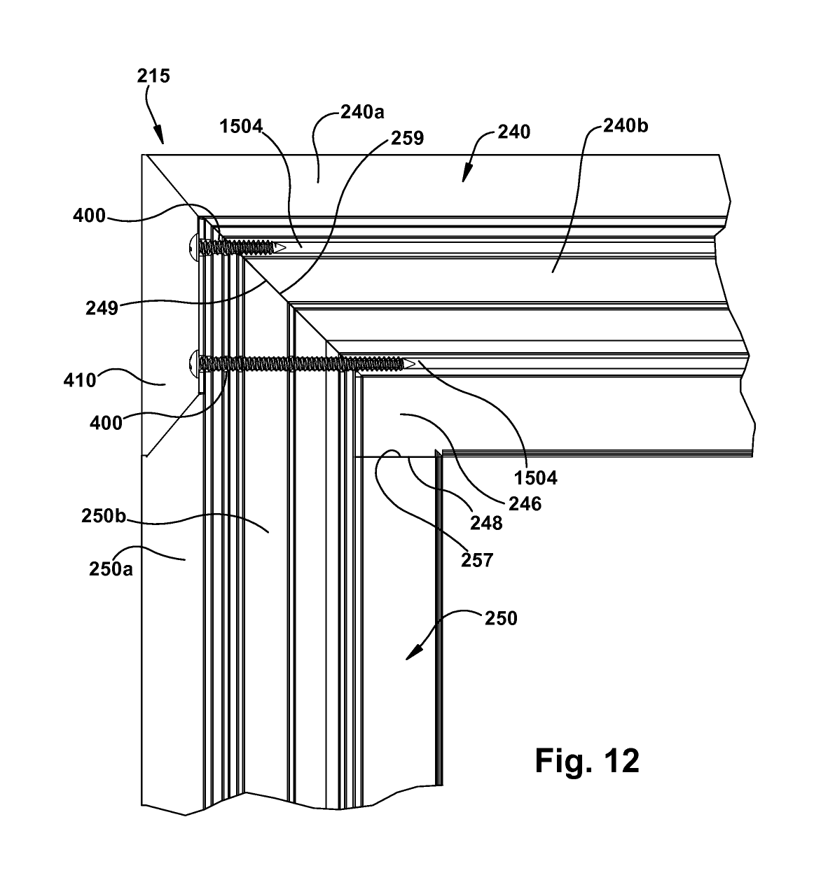

The cross-section of the interior hidden portion 240b is selected to allow the head rail member 240 to be attached to the jamb members 250. The illustrated interior portion 240b is generally rectangular. Interior support walls 1502 strengthen the interior portion 240b and may be configured in a wide variety of different ways. Elongated holes or bores 1504 are included to allow the head rail member 240 to be attached to the to the jamb members 250 by screws 243 (see FIGS. 4 and 12) that tap into the bores 1504. In another embodiment, the head rail member 240 is welded to the jamb members 250, and the bores and screws can be omitted. FIG. 15B illustrates the head rail 240 of FIG. 15A with a clip 112 added. In the illustrated embodiment, the clip 112 is attached with a screw 1550.

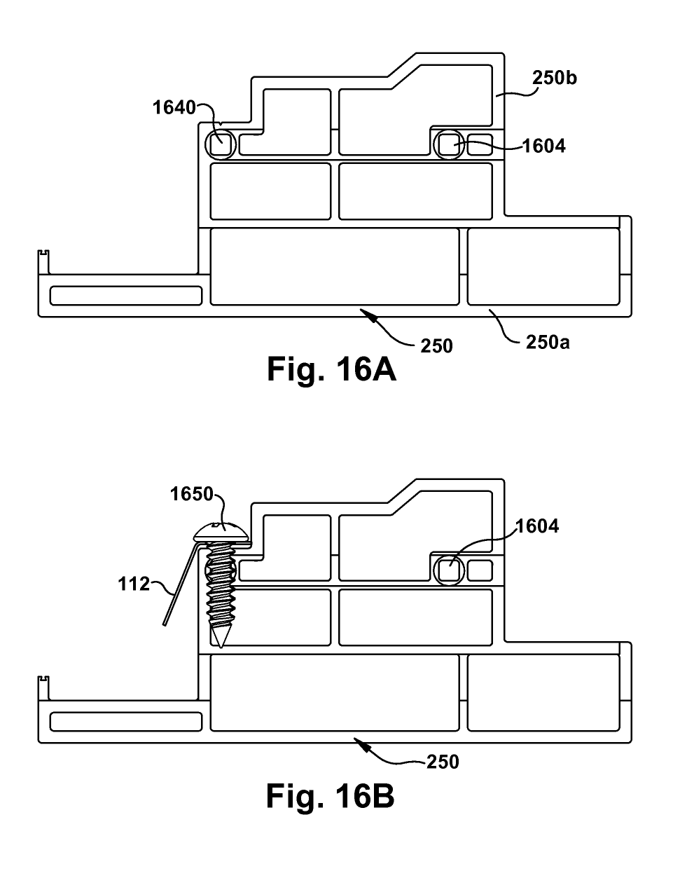

FIG. 16A is a sectional view of the window casing 200 through a jamb member 250. The jamb member 250 may be an extruded or molded plastic, vinyl, wood and plastic composite or similar material. The cross-section of the jamb members 250 are the same as the cross-section of the top rail member 240 and is therefore not described again in detail. The jamb member 250 includes an exterior visible portion 250a and an interior hidden portion 250b. The jamb members also include elongated bores 1604. FIG. 16B illustrates the jamb 250 of FIG. 16B with a clip 112 added. In the illustrated embodiment, the clip is attached with a screw 1650.

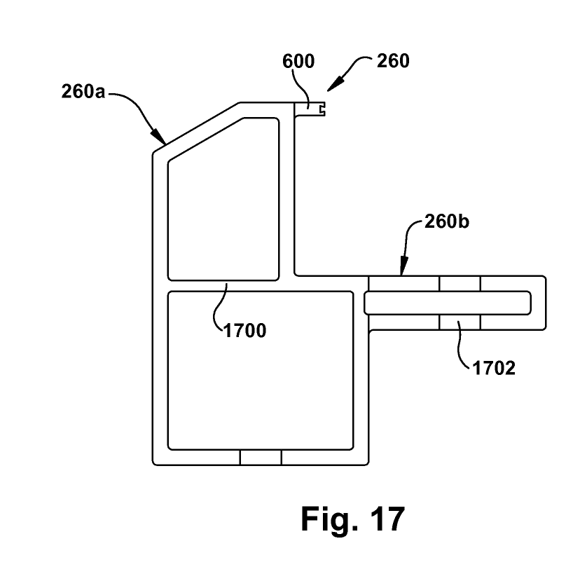

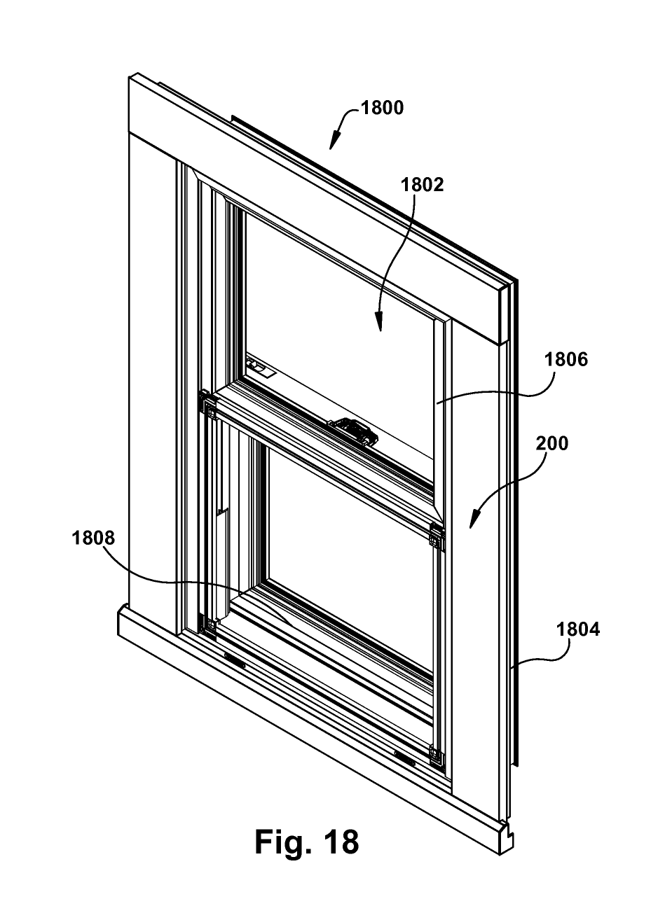

FIG. 17 is a sectional view of the window casing 200 through the bottom member 260 or bull nose. The bottom member 260 may be an extruded or molded plastic, vinyl, wood and plastic composite or similar material. The bottom member 260 includes an exterior visible portion 260a and a mounting portion 260b. While the surfaces of the visible portion 241a are generally shown as parallel planes, it will be appreciated that different profiles may be applied, incorporating curves, ridges, grooves, etc. to provide different decorative features.

The cross-section of the exterior visible portion 260a is selected to have a desired appearance. The exterior visible portion 260a is shaped to approximate a traditional wooden bull nose molding in the illustrated embodiment, but the section can be configured to create a wide variety of different appearances. Interior support wall 1700 strengthens the exterior visible portion 240a and may be configured in a wide variety of different ways.

The cross-section of the mounting portion 260b is selected to allow the bottom member 260 to be attached to the jamb members 250. The illustrated mounting portion 260b is generally rectangular. Holes 1702 through the mounting portion 260b are aligned with the elongated bores 1604 to allow bottom member 260 to be attached to the jamb members 250 by screws 253 that tap into the bores 1604 (See FIGS. 6 and 14). In an exemplary embodiment, spacing between the bores 1604 is maximized to maximize the stiffness of the joint.

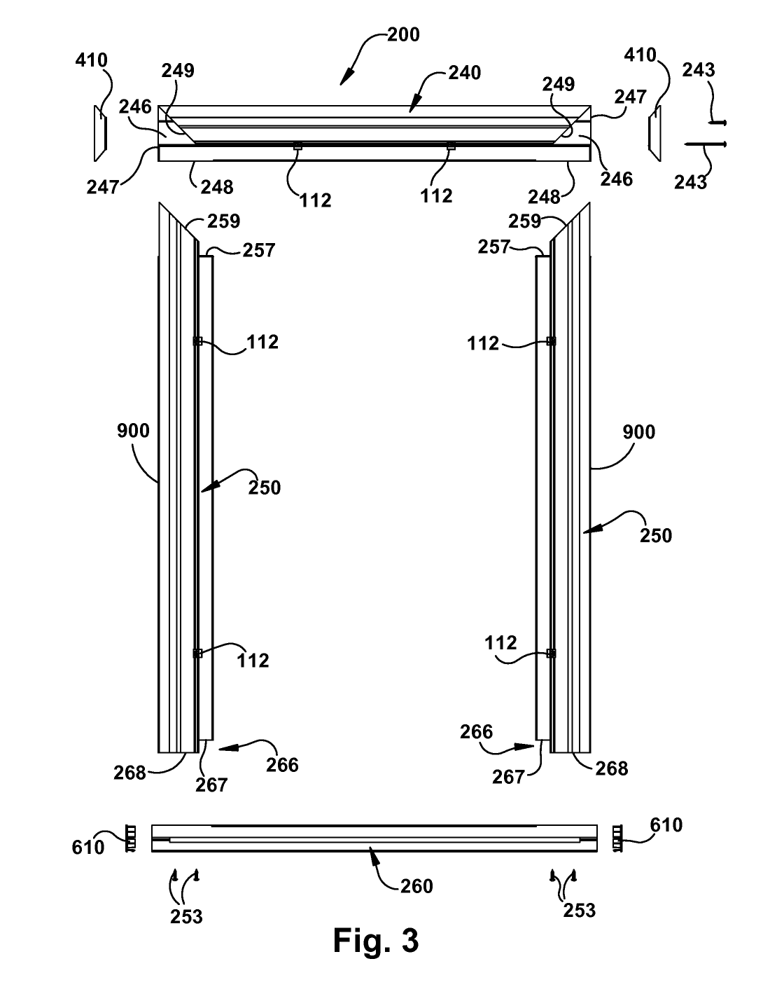

Referring to FIGS. 9A-9C, when the jamb members 250 are attached to the top rail member 240, by the mitered connection, the appearance of a butt joint is provided on the exterior of the window. Referring to FIG. 3, flanges 246 are provided on the head rail member 240 which are continuations of the visible portion 240a (i.e. a portion of the interior hidden portion 240b is removed) at each end of member 250. The flanges 246 terminate at an end surface 247 that is orthogonal to the lengthwise direction of the top rail member 240. The interior hidden portion 240b is also removed along portions of a lower edge 248 of the rail member 240. The portions of the interior hidden portion 240b may be removed by cutting or by any other manner. The portions of the interior hidden portion are removed to provide a mitered connection surface 249. In the illustrated embodiment, the mitered connection surface 249 forms a forty-five degree angle with respect to the lengthwise direction of the top rail member 240. The mitered connection surfaces 249 extend inward from the edges 247 of the flanges 246.

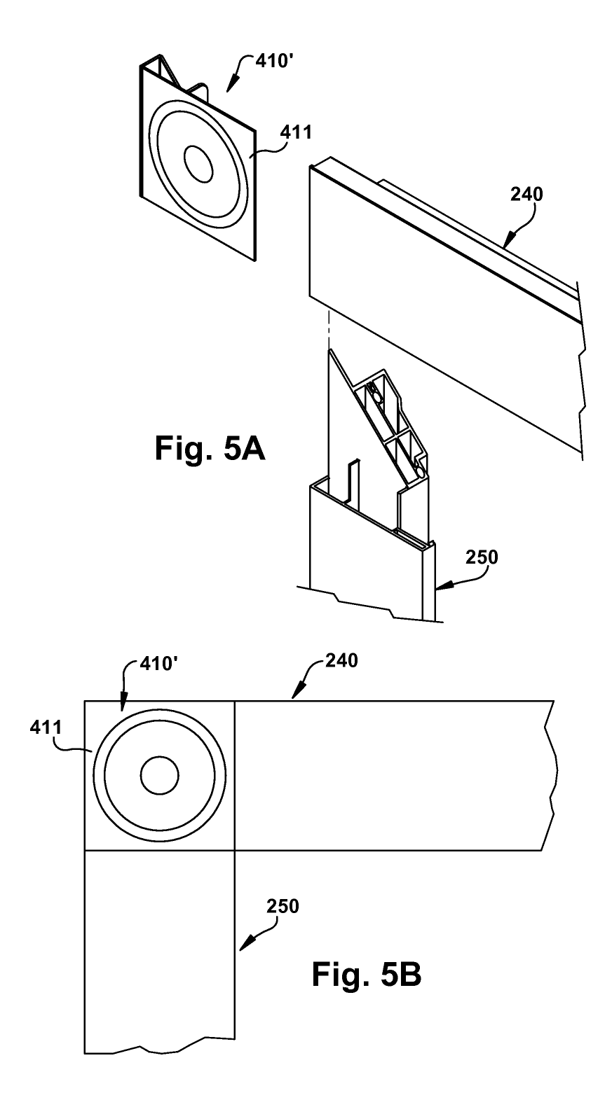

Referring to FIG. 5, recesses 256 are provided at the upper ends of the jamb members 250 to allow the jamb members 250 to mate with the top rail member 240. The recesses 256 are formed by removing a portion of the visible portion 250a. The recesses 256 terminate at end surfaces 247 that are orthogonal to the lengthwise direction of the jamb members 250. The portions of the visible portion 250a may be removed by cutting or by any other manner. The upper ends of the interior hidden portion are cut to provide a mitered connection surface 259. In the illustrated embodiment, the mitered connection surface 259 forms a forty-five degree angle with respect to the lengthwise direction of each jamb member 250. The mitered connection surfaces 259 extend inward toward edges of visible portion 250a.

Recesses 266 are provided at the lower ends of the jamb members 250 to allow the jamb members 250 to mate with the bottom member 260 or bull nose. The recesses 266 are formed by removing a portion of the visible portion 250a. The recesses 266 terminate at end surfaces 267 that are orthogonal to the lengthwise direction of the jamb members 250. The portions of the visible portion 250a may be removed by cutting or by any other manner. The lower ends of the interior hidden portion provide a connection surface 268. In the illustrated embodiment, the connection surface 268 forms a right angle with respect to the lengthwise direction of each jamb member 250.

Referring to FIG. 6, a portion of a flange 600 is removed at each end of the lower member 260 or bull nose member. The removal of the portion of the flange 600 allows the connection surfaces 268 at the lower ends of the jambs to engage the mounting portion 260b with the holes 1702 of the mounting portion 260b in alignment with the bores 1604 of the jambs 250.

Referring to FIGS. 2,3 and 9A-9-C., the illustrated flanges 246 of each top rail member overlap the recess 256 fanned on each adjacent jamb member to give the appearance of a butt joint. The squared end surfaces 247 of the top rail 240 are aligned with an outer side edge 900 of the jambs 250 in the illustrated embodiment. The lower edge 248 of the top rail 240 abuts or is slightly spaced apart from the end surfaces 256 of the jambs 240. This alignment forms the decorative surface which defines the butt joint. It will be appreciated that the decorative surface may have many different surface contours and orientations for providing different decorative/architectural features on the visible side of the casing.

Referring to FIG. 4, holes 400 or bores are defined at the top of each jamb member 250 through the interior hidden portion 250b. The holes 400 align with the bores 1504 in the top rail member. The mitered mating portions 249, 259 are connected by screws 243 that extend through the holes 400 and thread into the bores 1504 to form the structural connection between the top rail 240 and the jambs 250. In another embodiment, the head rail member 240 is welded to the jamb members 250, and the bores and screws can be omitted. Mating portions 249, 259 are planar surfaces extending generally at forty-five degree angles. Since members 240 and 250 preferably have identical cross-sectional profiles, the mating surfaces 251 and 254 will typically match up to one another substantially throughout the junction there between.

Referring to FIG. 4, an optional cap 410 is disposed at the top end of the jamb member 250 to hide the recess 256 at the top of the jamb member. The illustrated cap 410 includes a mounting flange 412 with holes 414 that are alignable with the holes 400 of the jamb members 250. The cap 410 is shaped to follow the contour of the side of the jamb member 250 and includes a flange 416 that covers the recess 256.

FIGS. 5A and 5B illustrate another embodiment of an optional cap 410′. The cap 410′ is configured to cover a portion of a front surface of the top rail 240 and/or the jamb 250 and provide a decorative appearance. The cap 410′ can be constructed in a wide variety of different manners to provide a decorative detail. In the embodiment illustrated by FIGS. 5A and 5B, the cap 410′ includes a flange 411 that covers a portion of the top rail 240. The flange 411 includes a decorative, aesthetically pleasing design. For example, the flange 411 may be molded to include flowers, geometric patterns, a rosette or any other aesthetically pleasing design.

Referring to FIGS. 6 and 14, the holes 1702 of the mounting portion 260b of the lower member 260 align with the bores 1604 in the jamb members 250. The bottom member 260 or bull nose is connected to the jambs 250 by the screws 253 that extend through the holes 1702 and thread into the bores 1604 to form the structural connection between the bottom member and the jambs 250. In another embodiment, the lower member 260 is welded to the jamb members 250, and the bores and screws can be omitted. The squared end surfaces 268 preferably abut the visible portion 260a of the bottom member 260 or are spaced apart from the bottom member by a small gap to provide the visual appearance of a butt joint. In an exemplary embodiment, the distance between the bores is 1604 is maximized to maximize the stiffness of the joint.

Referring to FIG. 6, optional caps 610 are disposed on the ends of the bottom member 260 or bull nose. The caps 610 hide the opening of the bottom member 260. The illustrated cap 610 is insertable into the openings of the bottom member 260. The cap 610 is shaped to follow the contour of the bottom member 260.

FIGS. 9-11 illustrate the assembled window casing 200. The screws 243, 253 that connect the members of the casing together are threaded into bores 1504, 1604 of the hidden portions 240b, 250b of the top rail 240 and the jambs 250. The screws 243, 253 are all hidden from view by the visible portions 240a, 250a, and 260a of the window casing members, when the window casing is assembled on a window. In the example illustrated by FIGS. 2-18, mounting clips 112 are attached to the hidden portions 240b, 250b of the top rail 240 and the jambs 250. The mounting clips 112 are also hidden from view by the visible portions 240a, 250a, and 260a of the window casing members, when the window casing is assembled on a window.

The window casing 200 can be used to trim a wide variety of different windows. FIG. 18 illustrates an example of a window assembly 1800 that includes the window casing 200 and a double hung window 1802. The double hung window 1802 includes a window frame 1804 and upper and lower sashes 1806, 1808 mounted in the window frame 1802, such that the sashes are slidable up and down in the frame 1802.

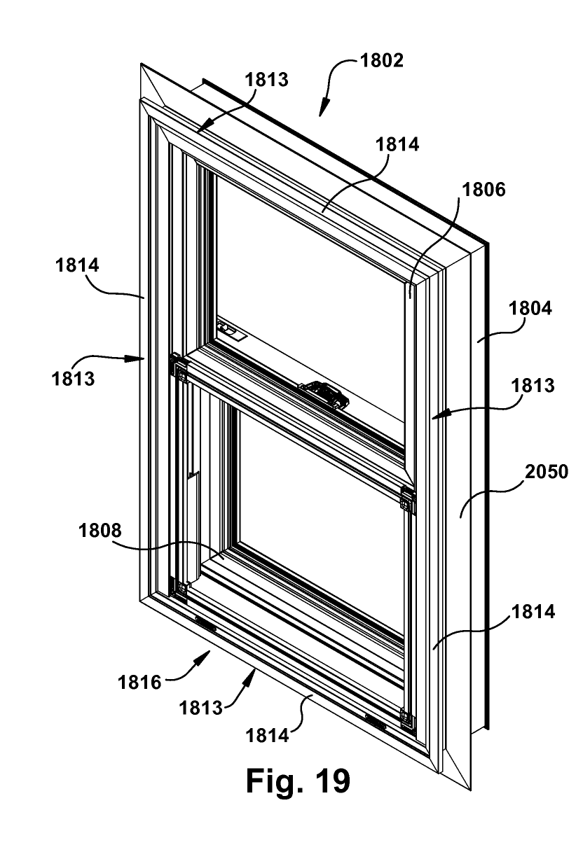

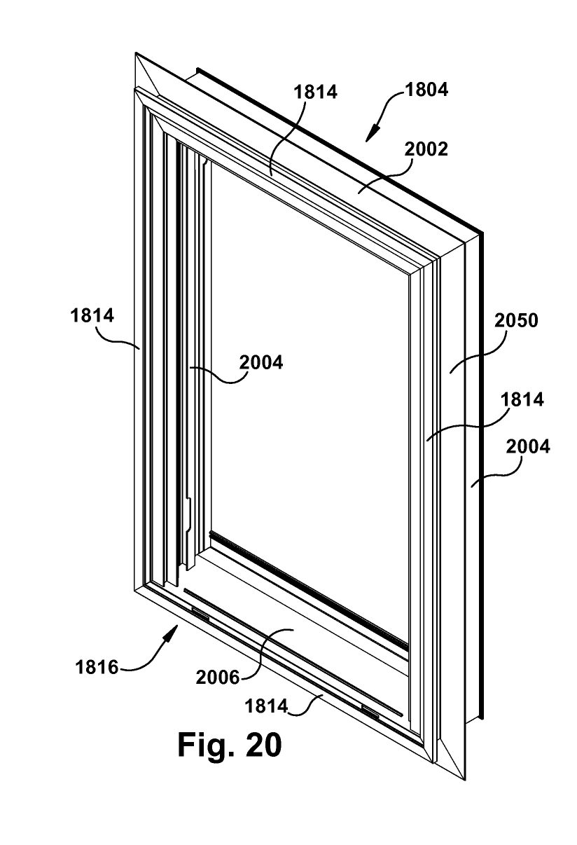

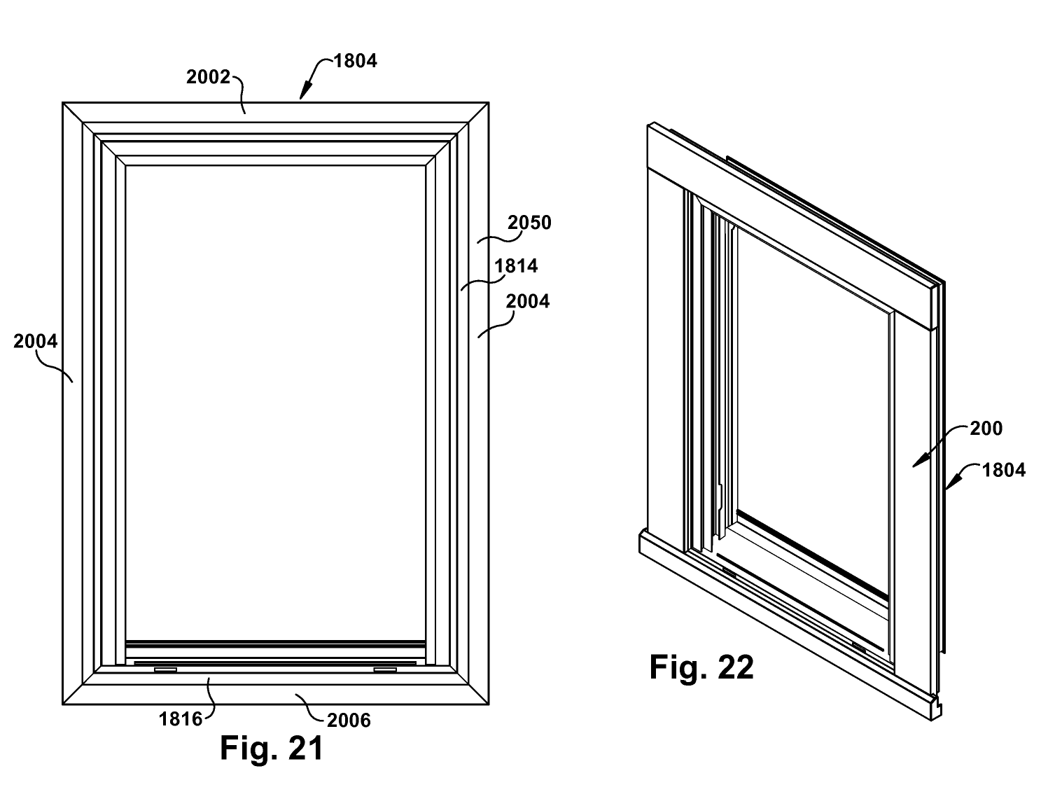

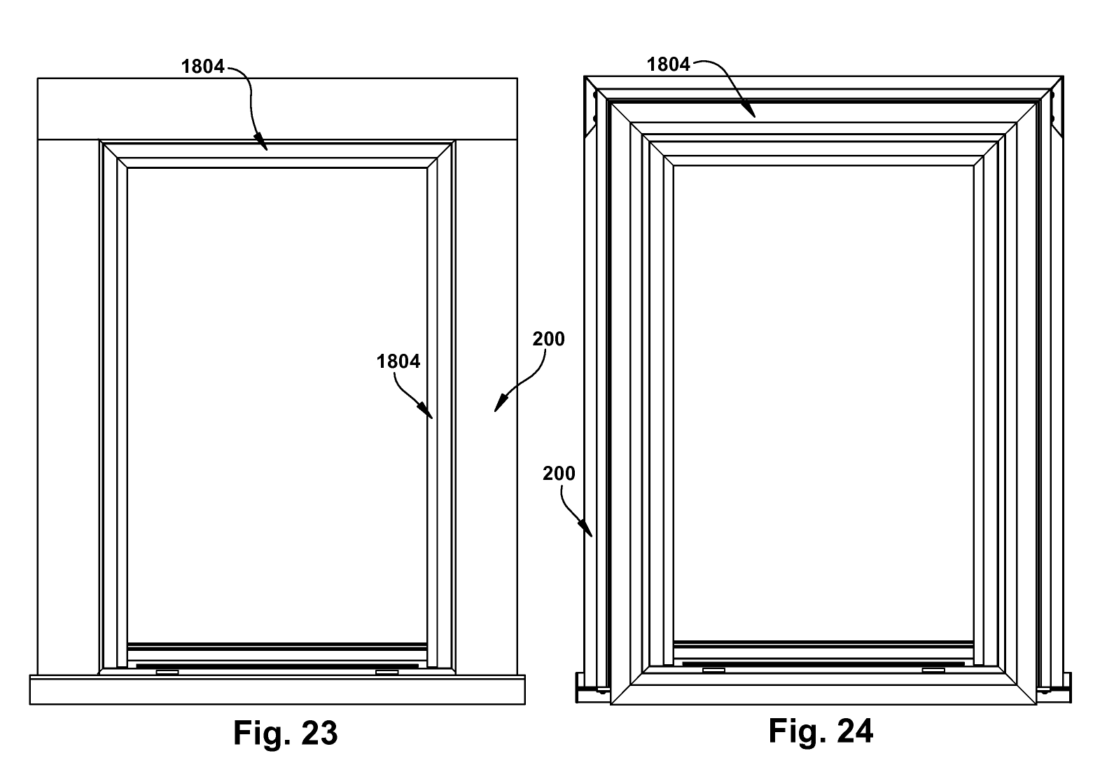

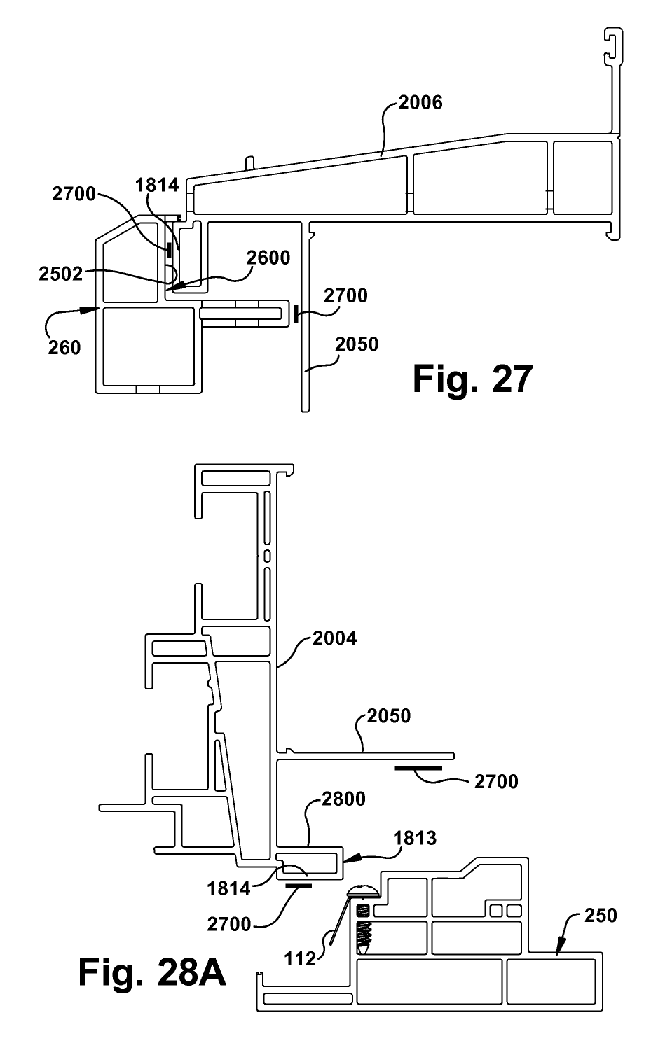

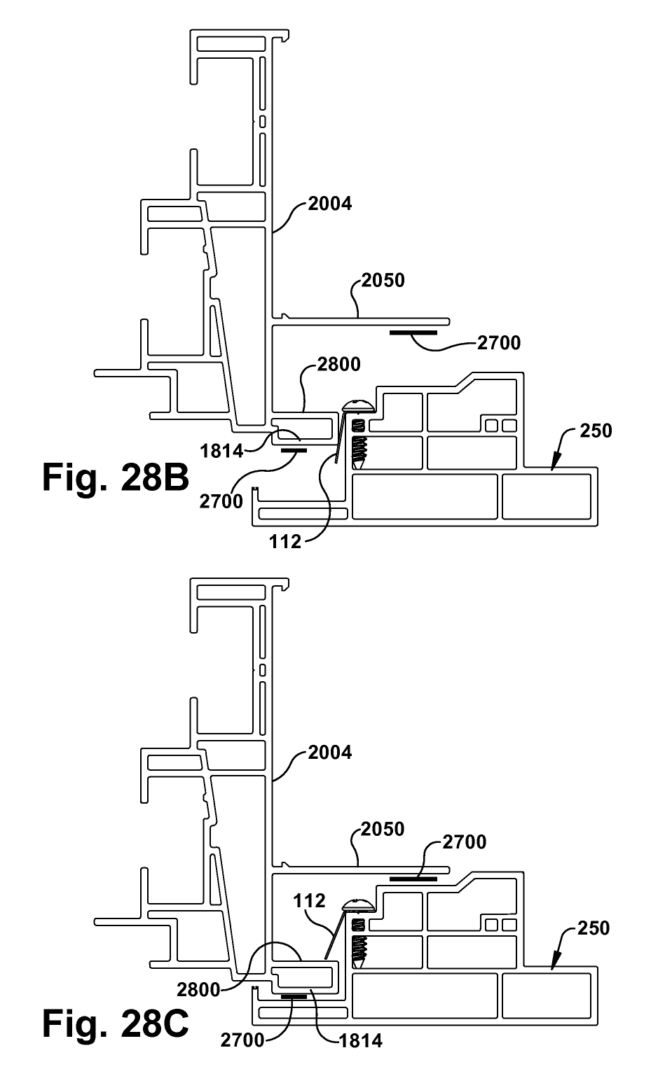

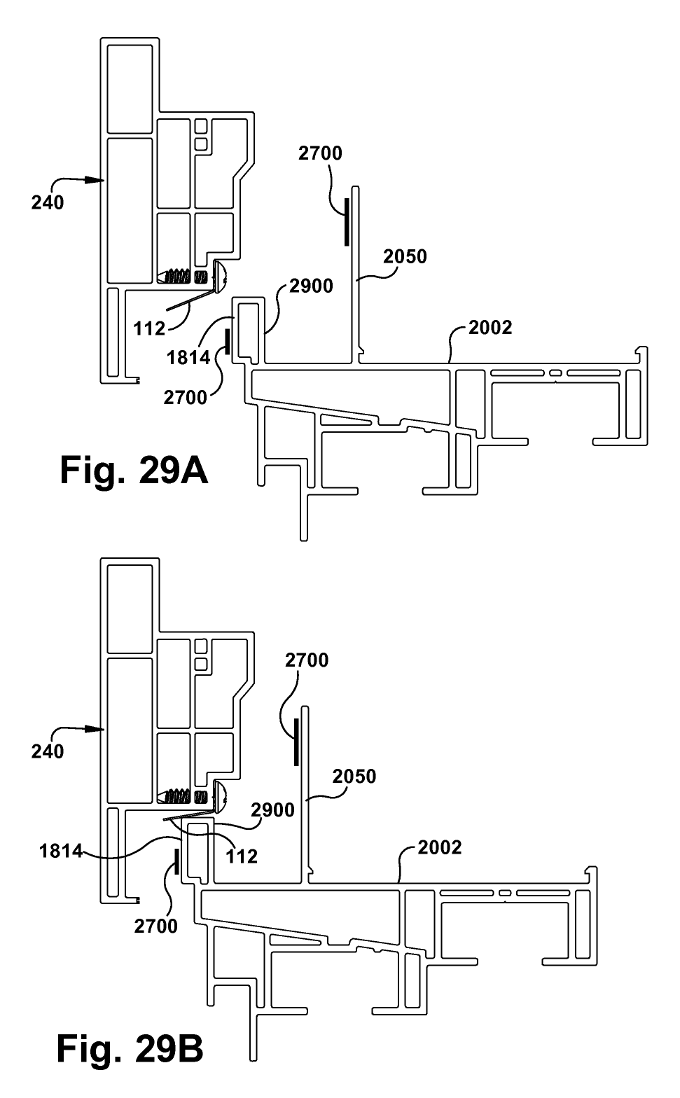

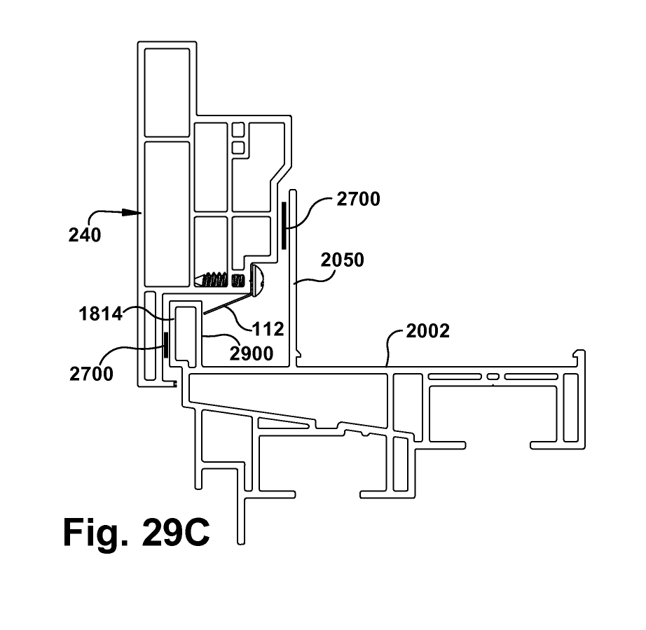

FIG. 20 illustrates the window frame 1804. The window frame includes a head rail 2002, a pair of upright jamb members 2004, and a bottom sill member 2006. FIG. 29 is a sectional view of the window assembly that shows the head rail 2002. FIG. 28 is a sectional view of the window assembly that shows a jamb 2004. FIG. 27 is a sectional view of the window assembly that shows the sill member 2006. However, the head member, jamb members, and sill members can take a wide variety of different forms.

The window frame 1802 includes a nail fin 2050 that is fastened to studs or other structural members around the rough window opening of the building to secure the window 1802 in the rough opening. A seal is provided between the nail fin 2050 and the window opening to inhibit water from passing between the window and the building opening.

The window frame 1804 includes a window casing mounting tab 1814 that extends around the periphery of the frame on an outer side 1816 of the frame (i.e. the side of the frame toward the outside of the building). The mounting tab 1814 can take a wide variety of different forms. In the embodiment illustrated by FIG. 18, the tab 1814 is part of a brickmold 1813 of the window frame profile. However, the tab 1814 can be formed by any portion of the window frame.

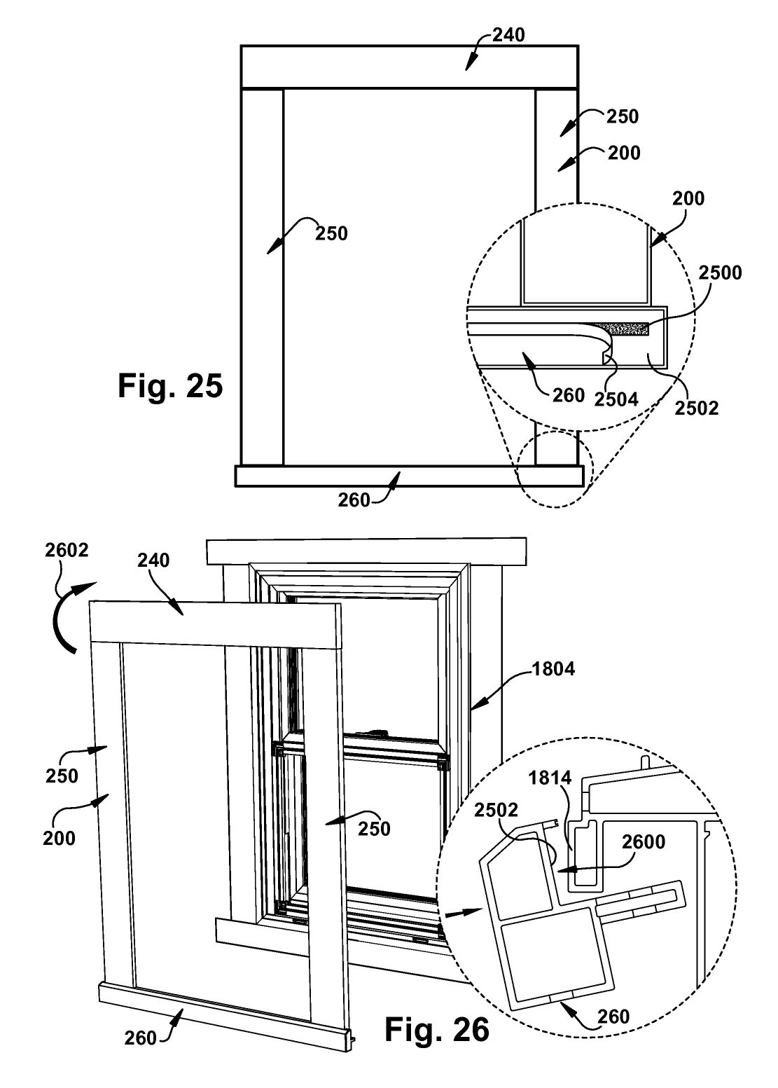

Referring to FIG. 25 an optional double sided adhesive 2500 such as double sided tape, is disposed on an inside surface 2502 of the lower casing member 260 or bull nose. A protective layer 2504 is removed from the double sided tape 2500 when the window casing is to be assembled onto the window frame 1802.

Referring to FIG. 26, a channel 2600 defined at the back side of the lower casing member 260 is placed around the window casing mounting tab of the sill 1814 of the window frame 1802. The casing 200 is rotated upward about the channel 2600 as indicated by arrow 2602 to move the jambs 250 and the head rail member 240 toward the window frame 1802. FIGS. 28A-28C illustrate that clips 112 attached to the jamb members 250 are compressed between the mounting tab 1814 and then expand to engage a back side 2800 of the tab 1814 as the casing is rotated as shown in FIG. 26. FIGS. 29A-29C illustrate that clips 112 attached to the top rail member 240 are compressed between the mounting tab 1814 and then expand to engage a back side 2900 of the tab 1814 as the casing is rotated as shown in FIG. 26. The clips 112 and/or the optional double sided tape retain the window casing 200 to the window frame 1802 at the installed position.

As described above, a seal will typically be provided between a building and the window frame 1802 to inhibit water from passing between the window frame and the building as is well known in the art. Additional seals between the casing 200 and the building or the casing and the window frame may be omitted, because the mounting of the casing to the window frame does not create any additional leak paths into the building. Referring to FIGS. 27, 28C, and 29 C, if seals between the window frame 1802 and the casing 200 are desired, optional seals 2700 can be provided between the casing 200 and the nail fin 2050 of the window frame 1802 and/or between the casing and the tab 1814.

Referring to FIG. 18, the visible portion of the window casing conceals the plurality of clips from view. In addition, the visible portion of the casing hides the clip screws and the screws that join the casing members together from view when the window casing is assembled with the window frame. The concealment of the clips and the screws from view provides the window assembly 1800 with a clean, aesthetically pleasing look.

In the illustrated embodiment, the clips 112 can be easily replaced by removing the screw and replacing the clip. If the casing 200 is damaged, the casing can be removed by pulling the casing away from the window frame 1800. The damaged component of the casing can be repaired or replaced and the casing can be easily reassembled with the window frame or a replacement casing can be easily assembled with the window frame.

The disclosed window casings have advantages over other available window casings. In an exemplary embodiment, the window casing is attached only to the frame. As a result, the casing does not need to be attached to the house or building with fasteners, such as nails or screws, that could provide a leak path into the house. In an exemplary embodiment, the window casing provides an aesthetically pleasing butt joint at the head and bull nose sill where the jambs end. The disclosed window casings are less costly than the costs associated with having a finish carpenter fabricate and install trim boards around the window on site. In an exemplary embodiment, the window casings are field replaceable. In an exemplary embodiment, the window casings are upgradeable. That is, the window casings can be added or changed in the future (after the initial installation of the window) by the homeowner. In an exemplary embodiment, the window casings use existing construction techniques. For example, the window and window casing can be installed to a single stud rough opening and do not require double studding. In an exemplary embodiment, the window casings have hidden fasteners and no caps or caulk is required to hide the fasteners. In an exemplary embodiment, the window casings attach to the window frame and do not affect window performance (structural or water).

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

While the invention has been described with reference to specific embodiments, it will be apparent to those skilled in the art that many alternatives, modifications, and variations may be made. Accordingly, the present invention is intended to embrace all such alternatives, modifications, and variations that may fall within the spirit and scope of the appended claims. The terms of the claims and their scope are not limited in any way by the descriptions of the embodiments set forth above.

1-19. (canceled)

20. A window assembly comprising:
a window frame including four members that are connected by miter joints that are visible from an external side of the window frame and an internal side of the window frame;
a window casing that includes a top member and a side member that are connected by mitered mating surfaces, wherein the window casing is attached to the external side of the window frame and provides the appearance that the top member and the side member are butt jointed.

21. The window assembly of claim 20 wherein the top member and the side member are connected together by screws that are hidden from view by the top member and the side member.

22. The window assembly of claim 20 wherein a lower horizontal member of the window casing includes a channel that accepts a projection of a lower horizontal member of the window frame.

23. The window assembly of claim 20 wherein a water seal is provided between the building and the window frame to inhibit water from passing between the window frame and the building opening and wherein additional seals are not required between the window casing and the window frame or the window casing and the building to inhibit water from entering the building between the window assembly and the building opening.

24. The window assembly of claim 20 wherein the window casing is configured to be removed from the window frame and replaced with a second window casing.
